(19) United States
(12) Patent Application Publication
(10) Pub. No.: US 2026/0190092 A1
(43) Pub. Date: Jul. 2, 2026

(54) DYNAMIC EXTENDED REALITY DEVICE ADAPTATION FOR POWER CONSUMPTION

(71) Applicant: Meta Platforms Technologies, LLC, Menlo Park, CA (US)

(72) Inventors: Liwen YU, Santa Clara, CA (US); Zhu JI, Saratoga, CA (US)

(73) Assignee: Meta Platforms Technologies, LLC, Menlo Park, CA (US)

(21) Appl. No.: 19/431,165

(22) Filed: Dec. 23, 2025

Related U.S. Application Data
(60) Provisional application No. 63/740,237, filed on Dec. 30, 2024.

(51) Int. Cl. H04W 72/0446

(52) U.S. Cl. CPC H04W 72/0446

(57) ABSTRACT

In some embodiments, a device may include a network interface wirelessly connected to a cellular network, one or more memories storing one or more applications, and one or more processors. The one or more processors may be configured to determine, using at least one of mobility of the device or connectivity of the device to the cellular network, a degree of precision. The degree of precision may include at least one of frame rate or resolution of data. The one or more processors may be configured to execute an application to generate first data having the degree of precision. The one or more processors may be configured to wirelessly transmit, via the network interface, the first data.

### CROSS-REFERENCE TO RELATED APPLICATION

This application claims priority to U.S. Provisional Patent Application No. 63/740,237 filed on December 30, 2024, which is incorporated by reference herein in its entirety for all purposes.

### FIELD OF DISCLOSURE

The present disclosure generally relates to extended reality (XR) technologies. More particularly, the present disclosure relates to dynamically balancing power consumption and computational performance in XR devices.

### BACKGROUND

The rapid evolution of extended reality (XR) technologies has impacted various industries, from healthcare, to manufacturing, to entertainment and gaming. However, the growth of XR experiences has been constrained by the challenges of balancing power consumption with the computational demands required to deliver immersive, high-quality XR experiences. XR devices, particularly those relying on mobile and wearable platforms, require substantial processing power to track user movements, render rich visuals, and ensure seamless interaction in real-time. This intensive computation often comes at the cost of increased power consumption, which can result in reduced battery life, device overheating, or poor user experience.

### SUMMARY

Various embodiments disclosed herein are related to a device. The device may include a network interface wirelessly connected to a cellular network, one or more memories storing one or more applications, and one or more processors. The one or more processors may be configured to determine, using at least one of mobility of the device or connectivity of the device to the cellular network, a degree of precision. The degree of precision may include at least one of frame rate or resolution of data. The one or more processors may be configured to execute an application to generate first data having the degree of precision. The one or more processors may be configured to wirelessly transmit, via the network interface, the first data.

Various embodiments disclosed herein are related to a method. The method may include determining, by one or more processors of a device, using at least one of mobility of the device or connectivity of the device to a cellular network, a degree of precision. The degree of precision may include at least one of frame rate or resolution of data. The method may include executing, by the one or more processors, an application, among one or more applications stored in one or more memories, to generate first data having the degree of precision. The method may include wirelessly transmitting, via a network interface wirelessly connected to the cellular network, the first data.

### BRIEF DESCRIPTION OF THE DRAWINGS

The accompanying drawings are not intended to be drawn to scale. Like reference numbers and designations in the various drawings indicate like elements. For purposes of clarity, not every component can be labeled in every drawing.

FIG. 1 is a diagram of an example wireless communication system, according to an example implementation of the present disclosure.

FIG. 2 is a diagram showing example components of a base station and a user equipment, according to an example implementation of the present disclosure.

FIG. 3 is an example of a device including a controller for dynamic extended reality (XR) device adaptation for power consumption, according to an example implementation of the present disclosure.

FIG. 4A and FIG. 4B illustrate an example of dynamic XR device adaptation for power consumption based on a movement or activity of a user wearing the XR device, according to an example implementation of the present disclosure.

FIG. 5 illustrates an example of dynamic XR device adaptation for power consumption based on a quality of the wireless connectivity of an XR device, according to an example implementation of the present disclosure.

FIG. 6A and FIG. 6B illustrate an example of dynamic XR device adaptation for power consumption based on a requirement of a query of a user, according to an example implementation of the present disclosure.

FIG. 7 is a flowchart showing a process for dynamic XR device adaptation for power consumption, according to an example implementation of the present disclosure.

FIG. 8 illustrates an example environment suitable for dynamic XR device adaptation for power consumption, according to an example implementation of the present disclosure.

FIG. 9 is a block diagram illustrating an exemplary computer system with which client devices may be implemented, according to an example implementation of the present disclosure.

### DETAILED DESCRIPTION

Before turning to the figures, which illustrate certain embodiments in detail, it should be understood that the present disclosure is not limited to the details or methodology set forth in the description or illustrated in the figures. It should also be understood that the terminology used herein is for the purpose of description only and should not be regarded as limiting.

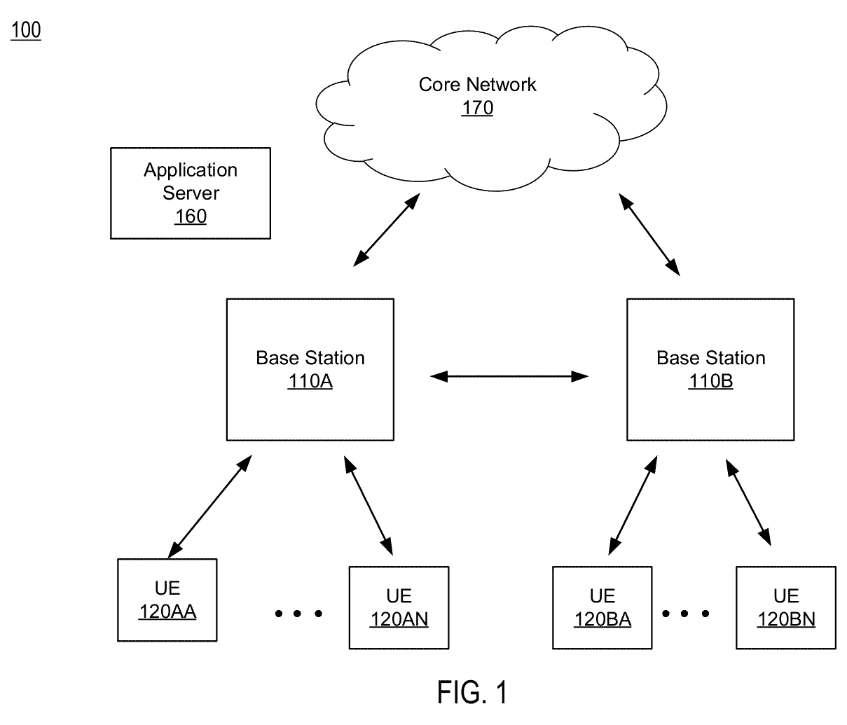

FIG. 1 illustrates an example wireless communication system 100. The wireless communication system 100 may include base stations 110A, 110B (also referred to as “wireless communication nodes 110” or “stations 110”) and user equipments (UEs) 120AA…120AN, 120BA…120BN (also referred to as “wireless communication devices 120” or “terminal devices 120”). The wireless communication link may be a cellular communication link conforming to 3G, 4G, 5G, 6G or other cellular communication protocols. In one example, the wireless communication link supports, employs or is based on an orthogonal frequency division multiple access (OFDMA). In one aspect, the UEs 120AA…120AN are located within a geographical boundary with respect to the base station 110A, and may communicate with or through the base station 110A. Similarly, the UEs 120BA…120BN are located within a geographical boundary with respect to the base station 110B, and may communicate with or through the base station 110B. A network between UEs 120 and the base stations 110 may be referred to as radio access network (RAN). In some embodiments, the wireless communication system 100 includes more, fewer, or different number of base stations 110 than shown in FIG. 1.

In some embodiments, the UE 120 may be a user device such as a mobile phone, a smart phone, a personal digital assistant (PDA), tablet, laptop computer, wearable computing device (e.g., head mounted display, smart watch), etc. Each UE 120 may communicate with the base station 110 through a corresponding communication link. For example, the UE 120 may transmit data to a base station 110 through a wireless communication link (e.g., 3G, 4G, 5G, 6G or other cellular communication link), and/or receive data from the base station 110 through the wireless communication link (e.g., 3G, 4G, 5G, 6G or other cellular communication link). Example data may include audio data, image data, text, etc. Communication or transmission of data by the UE 120 to the base station 110 may be referred to as an uplink communication. Communication or reception of data by the UE 120 from the base station 110 may be referred to as a downlink communication.

In some embodiments, the base station 110 may be an evolved node B (eNB), a gNodeB, a femto station, or a pico station. The base station 110 may be communicatively coupled to another base station 110 or other communication devices through a wireless communication link and/or a wired communication link. The base station 110 may receive data (or a RF signal) in an uplink communication from a UE 120. Additionally or alternatively, the base station 110 may provide data to another UE 120, another base station, or another communication device. Hence, the base station 110 allows communication among UEs 120 associated with the base station 110, or other UEs associated with different base stations.

In some embodiments, the wireless communication system 100 includes a core network 170. The core network 170 may be a component or an aggregation of multiple components that ensures reliable and secure connectivity to the network for UEs 120. The core network 170 may be communicatively coupled to one or more base stations 110A, 110B through a communication link. A communication link between the core network 170 and a base station 110 may be a wireless communication link (e.g., 3G, 4G, 5G, 6G or other cellular communication link) or a wired communication link (e.g., Ethernet, optical communication link, etc.). In some embodiments, the core network 170 includes user plane function (UPF), access and mobility management function (AMF), policy control function (PCF), etc. The UPF may perform packet routing and forwarding, packet inspection, quality of service (QoS) handling, and provide external protocol data unit (PDU) session for interconnecting data network (DN). The AMF may perform registration management, reachability management, connection management, etc. The PCF may help operators (or operating devices) to easily create and seamlessly deploy policies in a wireless network. The core network 170 may include additional components for managing or controlling operations of the wireless network. In one aspect, the core network 170 may receive a message to perform a network congestion control, and perform the requested network congestion control. For example, the core network 170 may receive explicit congestion notification (ECN) from a base station 110 and/or a UE 120, and perform a network congestion control according to the ECN. For example, the core network 170 may adjust or control an amount of data generated, in response to the ECN. Additionally or alternatively, the core network 170 may adjust or control an amount of data transmitted and/or received, in response to the ECN.

In some embodiments, the wireless communication system 100 includes an application server 160. The application server 160 may be a component or a device that generates, manages, or provides content data. The application server 160 may be communicatively coupled to one or more base stations 110A, 110B through a communication link. A communication link between an application server 160 and a base station 110 may be a wireless communication link (e.g., 3G, 4G, 5G, 6G or other cellular communication link) or a wired communication link (e.g., Ethernet, optical communication link, etc.). In one aspect, an application server 160 may receive a request for data from a UE 120 through a base station 110, and provide the requested data to the UE 120 through the base station 110. In one aspect, an application server 160 may receive a message to perform a network congestion control, and perform the requested network congestion control. For example, the application server 160 may receive explicit congestion notification (ECN) from a base station 110, a UE 120, or a core network 170, and perform a network congestion control according to the ECN. For example, the application server 160 may adjust or control an amount of data generated, in response to the ECN. Additionally or alternatively, the application server 160 may adjust or control an amount of data transmitted and/or received, in response to the ECN. Additionally or alternatively, the application server 160 may adaptively adjust or control an error correct rate. An error correction rate may be a rate of a number of error correction packets (also referred to as “protection packets”) per a set of packets for transmission. An error correction packet can be provided to help recover content. The application server 160 may adaptively adjust the error correction rate, according to a signal quality of a signal received by a UE 120 or a location of the UE 120 with respect to one or more base stations 110.

In some embodiments, communication among the base stations 110, the UEs 120, application server 160, and the core network 170 is based on one or more layers of Open Systems Interconnection (OSI) model. The OSI model may include layers including: a physical layer, a Medium Access Control (MAC) layer, a Radio Link Control (RLC) layer, a Packet Data Convergence Protocol (PDCP) layer, a Radio Resource Control (RRC) layer, a Non Access Stratum (NAS) layer or an Internet Protocol (IP) layer, and other layer.

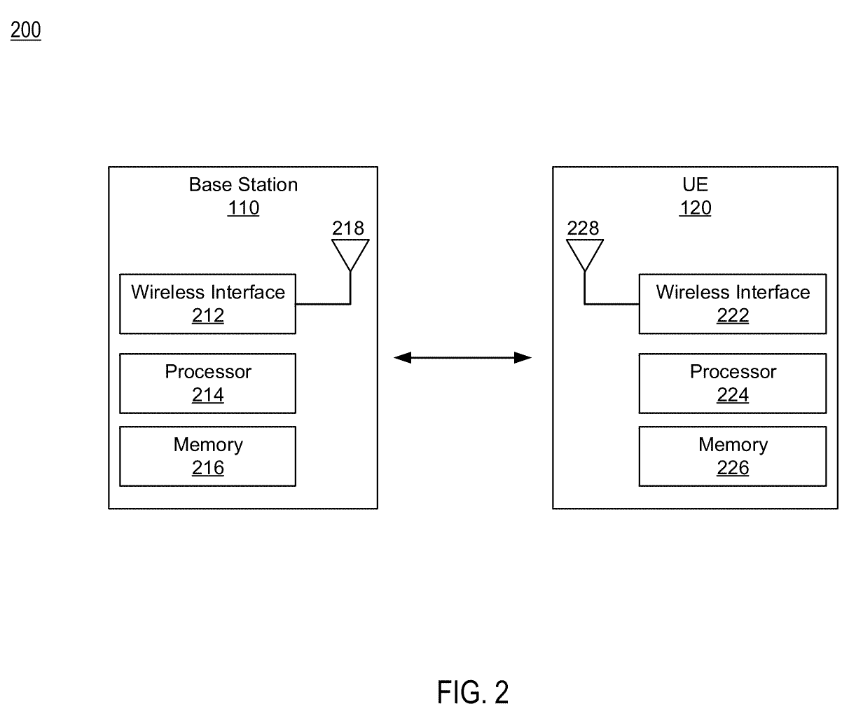

FIG. 2 is a diagram showing example components of a base station 110 and a user equipment 120, according to an example implementation of the present disclosure. In some embodiments, the UE 120 includes a wireless interface 222, a processor 224, a memory device 226, and one or more antennas 228. These components may be embodied as hardware, software, firmware, or a combination thereof. In some embodiments, the UE 120 includes more, fewer, or different components than shown in FIG. 2. For example, the UE 120 may include an electronic display and/or an input device. For example, the UE 120 may include additional antennas 228 and wireless interfaces 222 than shown in FIG. 2.

The antenna 228 may be a component that receives a radio frequency (RF) signal and/or transmits a RF signal through a wireless medium. The RF signal may be at a frequency between 200 MHz to 100 GHz. The RF signal may have packets, symbols, or frames corresponding to data for communication. The antenna 228 may be a dipole antenna, a patch antenna, a ring antenna, or any suitable antenna for wireless communication. In one aspect, a single antenna 228 is utilized for both transmitting a RF signal and receiving a RF signal. In one aspect, different antennas 228 are utilized for transmitting the RF signal and receiving the RF signal. In one aspect, multiple antennas 228 are utilized to support multiple-in, multiple-out (MIMO) communication.

The wireless interface 222 includes or is embodied as a transceiver for transmitting and receiving RF signals through one or more antennas 228. The wireless interface 222 may communicate with a wireless interface 212 of the base station 110 through a wireless communication link. In one configuration, the wireless interface 222 is coupled to one or more antennas 228. In one aspect, the wireless interface 222 may receive the RF signal at the RF frequency received through an antenna 228, and downconvert the RF signal to a baseband frequency (e.g., 0~1 GHz). The wireless interface 222 may provide the downconverted signal to the processor 224. In one aspect, the wireless interface 222 may receive a baseband signal for transmission at a baseband frequency from the processor 224, and upconvert the baseband signal to generate a RF signal. The wireless interface 222 may transmit the RF signal through the antenna 228.

The processor 224 is a component that processes data. The processor 224 may be embodied as field programmable gate array (FPGA), application specific integrated circuit (ASIC), a logic circuit, etc. The processor 224 may obtain instructions from the memory device 226, and execute the instructions. In one aspect, the processor 224 may receive downconverted data at the baseband frequency from the wireless interface 222, and decode or process the downconverted data. For example, the processor 224 may generate audio data or image data according to the downconverted data, and present an audio indicated by the audio data and/or an image indicated by the image data to a user of the UE 120. In one aspect, the processor 224 may generate or obtain data for transmission at the baseband frequency, and encode or process the data. For example, the processor 224 may encode or process image data or audio data at the baseband frequency, and provide the encoded or processed data to the wireless interface 222 for transmission.

The memory device 226 is a component that stores data. The memory device 226 may be embodied as random access memory (RAM), flash memory, read only memory (ROM), erasable programmable read-only memory (EPROM), electrically erasable programmable read-only memory (EEPROM), registers, a hard disk, a removable disk, a CD-ROM, or any device capable for storing data. The memory device 226 may be embodied as a non-transitory computer readable medium storing instructions executable by the processor 224 to perform various functions of the UE 120 disclosed herein. In some embodiments, the memory device 226 and the processor 224 are integrated as a single component.

In some embodiments, the base station 110 includes a wireless interface 212, a processor 214, a memory device 216, and one or more antennas 218. These components may be embodied as hardware, software, firmware, or a combination thereof. In some embodiments, the base station 110 includes more, fewer, or different components than shown in FIG. 2. For example, the base station 110 may include an electronic display and/or an input device. For example, the base station 110 may include additional antennas 218 and wireless interfaces 212 than shown in FIG. 2.

The antenna 218 may be a component that receives a radio frequency (RF) signal and/or transmits a RF signal through a wireless medium. The antenna 218 may be a dipole antenna, a patch antenna, a ring antenna, or any suitable antenna for wireless communication. In one aspect, a single antenna 218 is utilized for both transmitting a RF signal and receiving a RF signal. In one aspect, different antennas 218 are utilized for transmitting the RF signal and receiving the RF signal. In one aspect, multiple antennas 218 are utilized to support multiple-in, multiple-out (MIMO) communication.

The wireless interface 212 includes or is embodied as a transceiver for transmitting and receiving RF signals through one or more antennas 218. The wireless interface 212 may communicate with a wireless interface 222 of the UE 120 through a wireless communication link. In one configuration, the wireless interface 212 is coupled to one or more antennas 218. In one aspect, the wireless interface 212 may receive the RF signal at the RF frequency received through antenna 218, and downconvert the RF signal to a baseband frequency (e.g., 0~1 GHz). The wireless interface 212 may provide the downconverted signal to the processor 214. In one aspect, the wireless interface 212 may receive a baseband signal for transmission at a baseband frequency from the processor 214, and upconvert the baseband signal to generate a RF signal. The wireless interface 212 may transmit the RF signal through the antenna 218.

The processor 214 is a component that processes data. The processor 214 may be embodied as FPGA, ASIC, a logic circuit, etc. The processor 214 may obtain instructions from the memory device 216, and execute the instructions. In one aspect, the processor 214 may receive downconverted data at the baseband frequency from the wireless interface 212, and decode or process the downconverted data. For example, the processor 214 may generate audio data or image data according to the downconverted data. In one aspect, the processor 214 may generate or obtain data for transmission at the baseband frequency, and encode or process the data. For example, the processor 214 may encode or process image data or audio data at the baseband frequency, and provide the encoded or processed data to the wireless interface 212 for transmission. In one aspect, the processor 214 may set, assign, schedule, or allocate communication resources for different UEs 120. For example, the processor 214 may set different modulation schemes, time slots, channels, frequency bands, etc. for UEs 120 to avoid interference. The processor 214 may generate data (or UL CGs) indicating configuration of communication resources, and provide the data (or UL CGs) to the wireless interface 212 for transmission to the UEs 120.

The memory device 216 is a component that stores data. The memory device 216 may be embodied as RAM, flash memory, ROM, EPROM, EEPROM, registers, a hard disk, a removable disk, a CD-ROM, or any device capable for storing data. The memory device 216 may be embodied as a non-transitory computer readable medium storing instructions executable by the processor 214 to perform various functions of the base station 110 disclosed herein. In some embodiments, the memory device 216 and the processor 214 are integrated as a single component.

In one aspect, the rapid evolution of extended reality (XR) technologies has impacted various industries, from healthcare, to manufacturing, to entertainment and gaming. However, the growth of XR experiences has been constrained by the challenges of balancing power consumption with the computational demands required to deliver immersive, high-quality XR experiences. XR devices, particularly those relying on mobile and wearable platforms, require substantial processing power to track user movements, render rich visuals, and ensure seamless interaction in real-time. This intensive computation often comes at the cost of increased power consumption, which can result in reduced battery life, device overheating, or poor user experience.

As the demand for more immersive and sophisticated XR experiences increases, there is a need for an efficient method of balancing power and performance. Users expect longer usage periods without sacrificing the responsiveness, fluidity, and visual quality of XR applications. Current solutions, such as fixed power budgets, rigid performance targets, or simplistic optimization approaches, fail to adapt dynamically to changing environmental conditions or user behavior, resulting in either wasted power or suboptimal performance.

Moreover, the integration of artificial intelligence (AI) on XR devices has enabled users to interact with XR devices in more natural and intuitive ways. For one example, multimodal AI (MMAI) allows devices to understand and respond to user input in multiple formats, including text, voice, and images. For another example, live AI enables users to engage in real-time, interactive, and natural conversations with AI. As AI applications become increasingly powerful, power consumption becomes a critical consideration. Always-on AI applications may require devices to be constantly powered, which can lead to battery drain and reduced device lifespan. The term “application(s)” or “AI application(s)” may refer to any software, firmware, or logic executed by a device to perform tasks, including but not limited to artificial intelligence functions such as image recognition, natural language processing, augmented reality, or other computational operations. In some embodiments, applications may be configured to interact with local or remote servers, process sensor data, or provide user-facing services.

To address these problems, the present disclosure includes systems, devices, and methods for dynamic XR device adaptation. In some embodiments, systems and methods can optimize power consumption while maintaining optimal AI performance. In some embodiments, systems and methods can balance power consumption and performance thereby delivering a seamless and enjoyable XR user experience, supporting device efficiency, and achieving sustainability and cost effectiveness. In some embodiments, systems and methods can provide for dynamic, real-time solutions for balancing power consumption and computational performance in XR devices (e.g., XR headsets).

In some embodiments, systems and methods can dynamically allocate resources (e.g., compute resource, battery power, etc.) based on a movement or activity of a user wearing an XR device, based on a quality of the wireless connectivity of an XR device, or based on a requirement of a query of a user. The term “connectivity” of a device to the cellular network may refer to any aspect of the device’s ability to communicate with a cellular network, including signal strength, signal quality, network congestion, cell loading, or other radio frequency metrics. Connectivity may be assessed using received signal strength indicator (RSSI), reference signal received power (RSRP), signal-to-interference-plus-noise ratio (SINR), or other parameters. The term “cell loading” may refer to any condition or metric indicating the utilization, congestion, or resource availability of a cellular network cell. Cell loading may be determined based on network resource allocation, scheduling delays, explicit congestion signals, or other indicators provided by the network or measured by the device (e.g., measured by a network interface).

In some embodiments, systems (e.g., XR system) and methods can adjust a frame rate of data (e.g., video data) in real-time based on a movement or an activity of a user. When a user moves at high speeds or rapidly changes the view of the user, an XR system may increase the frame rate by a pre-defined step size to ensure accurate AI performance. When the user is stationary or not moving the head of the user, the system may reduce the frame rate to conserve power and minimize unnecessary transmissions. In some embodiments, the system can perform real-time detection of user movement and activity, automatic and dynamic adjustment of frame rate based on user movement and activity, and/or switching to power-saving mode for stationary users. In this manner, the system can improve performance and accuracy of AI applications in high-speed and dynamic environments, and can reduce power consumption and prolong battery life for stationary users.

In some embodiments, when a user experiences poor cellular connectivity (e.g., cell edge, cell is loaded) and is power limited, the XR system can dynamically reduce a frame rate of video data and/or a resolution of video/image data for remote AI applications (e.g., cloud AI applications). In some embodiments, when a user experiences poor cellular connectivity (e.g., when the user is near a cell edge, or the cell is loaded) and is power limited, the XR system can automatically switch from the remote AI server (e.g., cloud AI) to an on-device AI processor when latency requirements cannot be met. In some embodiments, the system may perform effective trade-off between device power and AI performance and/or real-time monitoring of wireless conditions and power levels to trigger power saving mode. In this manner, the system can improve battery life and reduce power consumption in device power-limited scenarios, and can enable enhanced AI performance and user experience through reduced latency by on-device AI (e.g., on-device AI server).

In some embodiments, the system can dynamically adjust video/image resolution based on the requirements of a user query (e.g., how much processing power or resource is required to process the user query). The term “user query” may refer to any input, request, or command provided by a user to a device or application, including spoken language, text, gestures, images, or other forms of interaction. In some embodiments, the system can analyze user queries to determine intent, required data precision, or appropriate system response. When low-resolution images/video data are sufficient (for the AI server to process the user query), low resolution images/video data may be transmitted to optimize device power and network capacity. For example, a high-resolution user query that requires high-resolution may include, for example, “Translate the menu into English,” and a low-relation user query that requires low-resolution may include, for example, “What’s the name of this tropical fruit?” The system may perform real-time analysis of user queries to determine required video/image resolution, dynamic adjustment of video/image resolution based on query requirements, and/or optimization of network capacity and device power. In this manner, the system can reduce network congestion and improve overall network performance, can increase battery life and reduce power consumption for devices, and/or can enhance user experience through optimized image quality and reduced latency.

Embodiments in the present disclosure have at least the following advantages and benefits.

First, systems and methods according to some embodiments can significantly improve device battery life and operational efficiency by dynamically adjusting frame rate and image resolution in response to user activity, device mobility, and network conditions. In some embodiments, by intelligently lowering these parameters when the user is stationary or when network connectivity is poor, a system can conserve power without sacrificing essential functionality, allowing users to enjoy longer usage times and reducing the frequency of charging interruptions.

Second, systems and methods according to some embodiments can enhance the overall user experience by maintaining optimal AI performance and responsiveness, even in challenging environments. In some embodiments, when the device detects high user mobility or favorable network conditions, a system can automatically increase frame rate and resolution, ensuring that AI applications deliver accurate, real-time results. This adaptive approach can allow users to interact seamlessly with AI services, whether they are moving rapidly or engaging in complex tasks that require high-fidelity data.

Third, systems and methods according to some embodiments can optimize network resource usage and reduces congestion by tailoring the resolution of data transmitted to the AI engine based on the semantic requirements of each user query. In some embodiments, by performing real-time analysis of the query and transmitting only the necessary level of detail, a system can minimize unnecessary data transmission, improve network efficiency, and enable scalable deployment of AI services across a wide range of devices and environments. These advantages collectively demonstrate the system’s ability to balance power consumption, AI performance, and network efficiency, providing a robust and intelligent solution for next-generation XR and wearable devices.

With the foregoing in mind, the figures and description below illustrate various examples of systems and/or methods for dynamic XR device adaptation for power consumption. It should be noted that the figures and description below are non-limiting examples and can be implemented as any of various other configurations while remaining within the scope of the present disclosure.

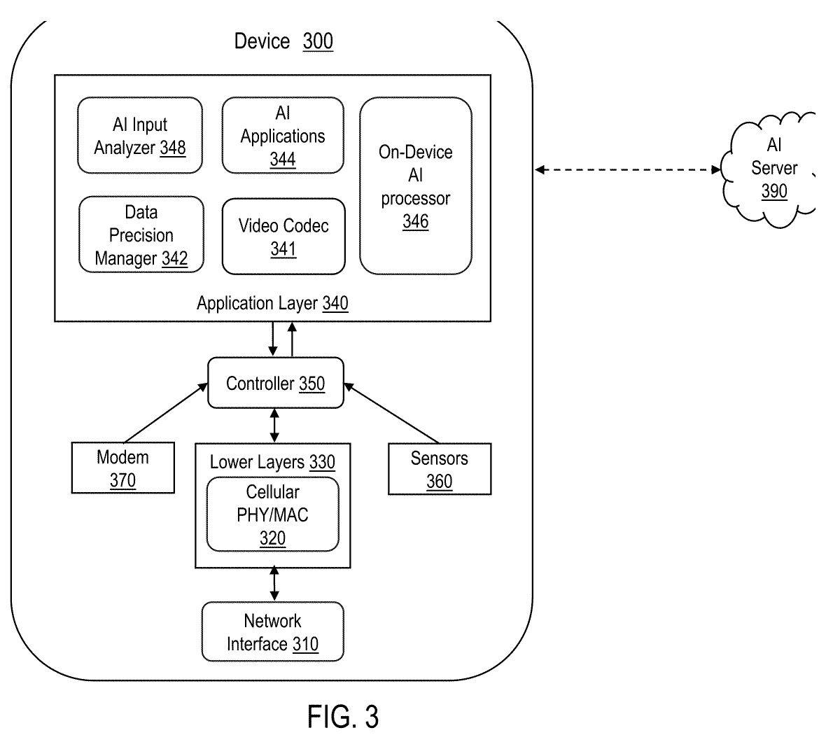

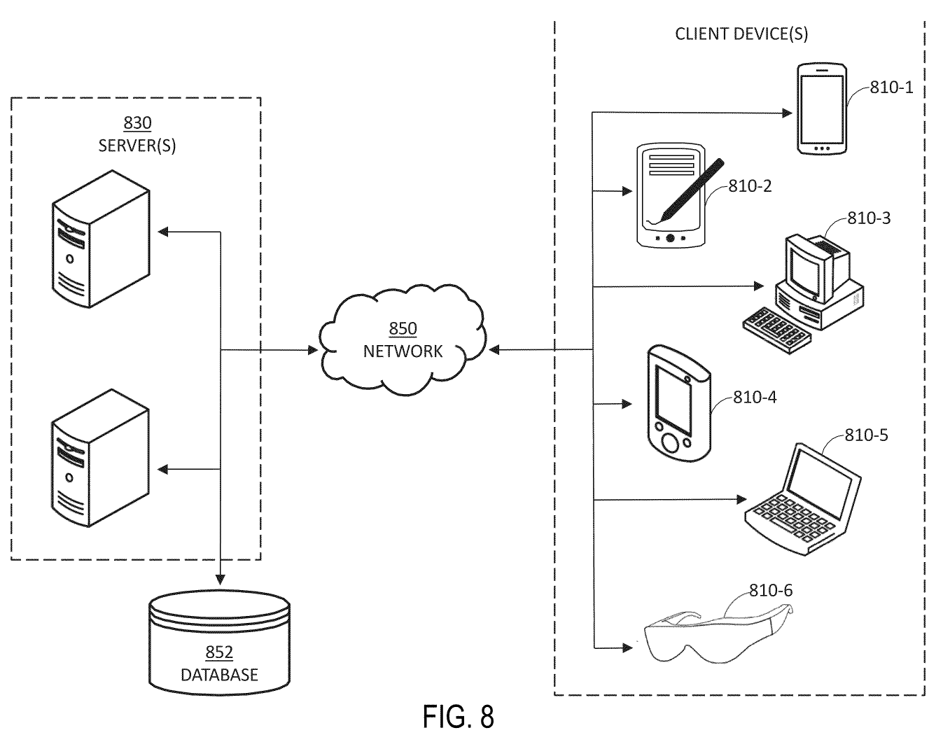

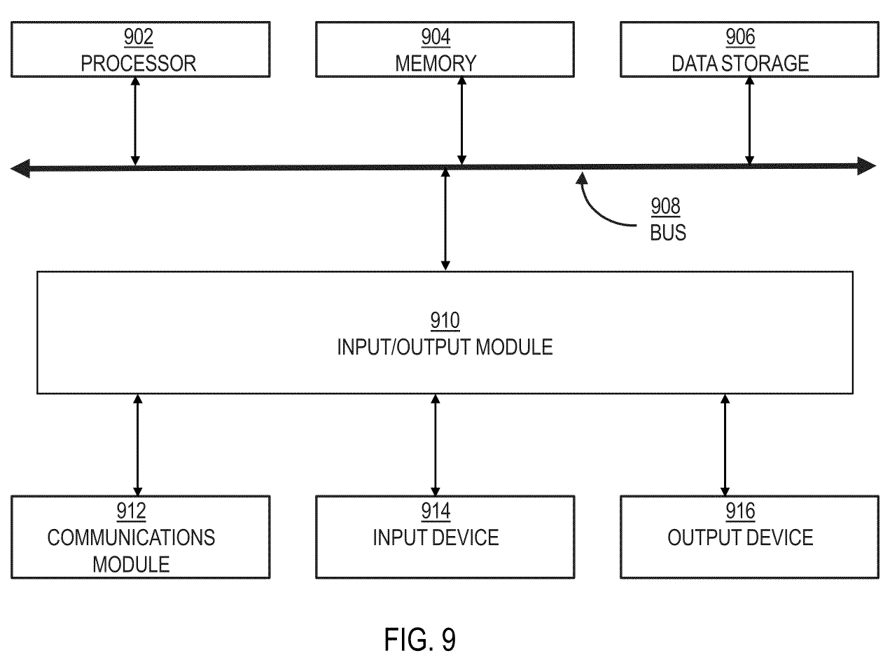

FIG. 3 shows an example of a device 300 including a controller for dynamic extended reality (XR) device adaptation for power consumption, according to an example implementation of the present disclosure. FIG. 3 illustrates a schematic block diagram of a device architecture configured for dynamic adaptation of AI applications to optimize power consumption and performance in extended reality (XR) and wearable devices. The device 300 may have configurations similar to those of the base station 110, UE 120 (see FIG. 2), servers 830, client devices 810 (see FIG. 8), and/or computer system 900 (see FIG. 9).

In some embodiments, the device 300 may include several interconnected modules (e.g., video codec 341, data precision manager 342, one or more AI applications 344, on-device AI processor 346, controller 350) and layers (e.g., network layers including an application layer 340, lower layers 330 such as cellular PHY/MAC layers 320), each responsible for specific aspects of data processing, connectivity, and AI adaptation. In some embodiments, each of the video codec 341, the data precision manager 342, the one or more AI applications 344, the on-device AI processor 346 , the application layer 340, the lower layers 330, the cellular PHY/MAC layers 320 may be implemented in hardware, firmware, software or a combination thereof.

In some embodiments, the device 300 may include a network interface 310, which performs wireless communication with external networks, such as cellular or Wi-Fi networks. The term “network interface” may refer to any hardware, software, or combination thereof that enables a device to communicate with one or more networks, such as cellular, Wi-Fi, Bluetooth, or other wireless or wired networks. In some embodiments, the network interface 310 may comprise a modem, radio transceiver, or other circuitry capable of transmitting and receiving data over a network. In some embodiments, the network interface 310 may be coupled to a modem 370, which may manage the physical and medium access control (PHY/MAC 320) layers of cellular connectivity, enabling the device to monitor and respond to varying network conditions, such as signal strength, cell loading, and congestion. In some embodiments, signal quality metrics such as RSSI, RSRP, and/or SINR can be obtained, measured or calculated by at least one of the network interface 310 or PHY/MAC layer 320 . The term “modem” may refer to any hardware, software, or combination thereof that is configured to enable a device to transmit and receive data over one or more communication networks. In some embodiments, a modem may include circuitry or logic for modulating and demodulating signals, supporting various wireless or wired protocols such as cellular, Wi-Fi, Bluetooth, Ethernet, or other standards. The modem may be integrated within a device or provided as a separate component, and may operate in conjunction with other network interface elements to facilitate connectivity, data exchange, and communication with remote servers, base stations, or other devices.

In some embodiments, above the lower layers 330, an application layer 340 may include or host various AI applications 344. These applications may use real-time sensor data and network information to deliver intelligent services to the user. The application layer 340 may interface or communicate with a video codec 341 for encoding and decoding video streams. The application layer may interface or communicate with a controller 350 that perform or control the dynamic adaptation logic based on contextual inputs (e.g., data representing a degree of mobility of the device, a degree of connectivity to the cellular network, a user query, etc.). The term “application layer” may refer to any software, firmware, or logical layer of a device or system that is configured to manage, execute, or support higher-level functions, services, or applications. In some embodiments, the application layer may include one or more modules, programs, or AI applications that perform tasks such as data processing, user interaction, network communication, multimedia handling, or context aware decision making. The application layer may interface with lower layers (e.g., transport, network, or physical layers) to obtain data, issue commands, or exchange information, and may operate in coordination with controllers, sensors, AI processors, or network interfaces. The application layer may be implemented across various hardware or software platforms and may support extensible or modular functionality depending on system requirements.

In some embodiments, the AI input analyzer 348 may receive input data (e.g., a user query, image or video data) from the user or sensors and perform semantic analysis to determine the requirements of the AI task. The term “semantic analysis” of a user query may refer to any process or technique for interpreting the meaning, intent, or context of a user’s input, using natural language processing, pattern recognition, or other AI methods. Semantic analysis may be used to determine the appropriate resolution, frame rate, or other operational parameters for processing the query. For example, the analyzer 348 may distinguish between queries that require high-resolution image processing (e.g., translating a menu) and those that can be satisfied with lower resolution (e.g., identifying a fruit).

In some embodiments, the data precision manager 342 may operate in conjunction with the AI input analyzer or other components (e.g., AI application 344, controller 350, etc.) to dynamically adjust the frame rate of video data and/or the resolution of video or image data transmitted to or from the AI application 344 (and transmitted from or to the AI server 390). The term “frame rate” of data may refer to the frequency at which frames of data, such as images or video, are generated, processed, or transmitted by a device. Frame rate may be expressed in frames per second (fps) or other units, and may be dynamically adjusted based on device context, user activity, or network conditions. The term “resolution” of data may refer to any measure of the detail or clarity of data, such as the number of pixels in an image or video frame, or the granularity of sensor readings. Resolution may be selected or adjusted in response to application requirements, user queries, or resource constraints (e.g., constraints on power or computing).

In some embodiments, the adjustment of the frame rate of video data and/or the resolution of video or image data can be performed based on both the nature of the user’s query (e.g., a degree complexity or computing overhead to process the query) and the current network and power conditions, optimizing device power consumption and network resource usage. In some embodiments, this adjustment can be performed based on at least one of a degree of mobility of the device, a degree of connectivity to the cellular network, a degree of complexity or computing overhead to process the query, or resource constraints (e.g. power consumption or computing overhead).

In some embodiments, the on-device AI processor 346 can perform local execution of AI tasks when network connectivity is poor or latency requirements cannot be met by cloud-based AI services (e.g., AI server 390). In some embodiments, the on-device AI processor 346 can ensure that AI functions (e.g., critical AI functions) remain available to the user, even in power- limited or congested network scenarios. The term “AI service” may refer to any software, firmware, or logic configured to perform artificial intelligence operations, such as inference, learning, or data analysis. The AI service may be implemented locally on the device, remotely on a server, or in a distributed manner across multiple platforms. The term“ on-device AI processor” may refer to any hardware, software, or logic within a device (e.g., device 300) that is capable of executing AI algorithms, such as neural network inference, image processing, or natural language understanding. The on-device AI processor 346 may operate independently or in conjunction with remote AI servers (e.g., AI server 390).

In some embodiments, one or more sensors 360 may be integrated throughout the device 300 to continuously monitor user movement, activity, and/or environmental conditions. The term “sensor(s)” may refer to any combination of hardware components capable of detecting physical, environmental, or contextual information, such as accelerometers, gyroscopes, magnetometers, GPS receivers, cameras, microphones, or other sensing devices. These sensors 360 may include accelerometers, gyroscopes, GPS receivers, and/or other modalities, providing data that informs the dynamic adaptation of frame rate and/or resolution in response to user mobility and context (e.g., network condition, power consumption, AI requirement of applications or users, etc.).

In some embodiments, the AI server 390 may be remote or local, and configured to execute AI inference tasks and communicate results back to the device 300. The term “AI server” may refer to any computing system, device, or platform configured to execute AI tasks, process data, or provide AI-related services to one or more client devices. The AI server may be located remotely in the cloud, locally on the device, or in a hybrid configuration. The server 390 may interact or communicate with the application layer 340, the data precision manager 342, and/or the video codec 341 to ensure that data is processed at the appropriate level of precision, balancing power consumption and performance.

In some embodiments, the controller 350 may manage, control, coordinate, or orchestrate the flow of data between the network interface 310, sensors 360, AI applications 344, data precision manager 342, and/or the AI servers 346, 390. When the device 300 detects high user mobility or favorable network conditions, the controller 350 may increase the frame rate and/or resolution to enhance AI performance. Conversely, when the user is stationary or the device is power-limited, the controller 350 may reduce frame rate and/or resolution, and may switch AI processing to the on-device module (e.g., on-device AI processor 346) to conserve battery life. The term “controller” may refer to any hardware, software, firmware, or combination thereof that is configured to manage, coordinate, or regulate the operation of one or more components or processes within a device or system. In some embodiments, a controller may include logic or circuitry for receiving inputs from sensors, user interfaces, or network connections, and for executing instructions or algorithms that determine how data is processed, transmitted, or displayed. The controller may be implemented as a dedicated microcontroller, a general-purpose processor, a programmable logic device, or as part of an integrated system-on-chip, and may operate independently or in conjunction with other modules to facilitate adaptive, context-aware, or intelligent device behavior.

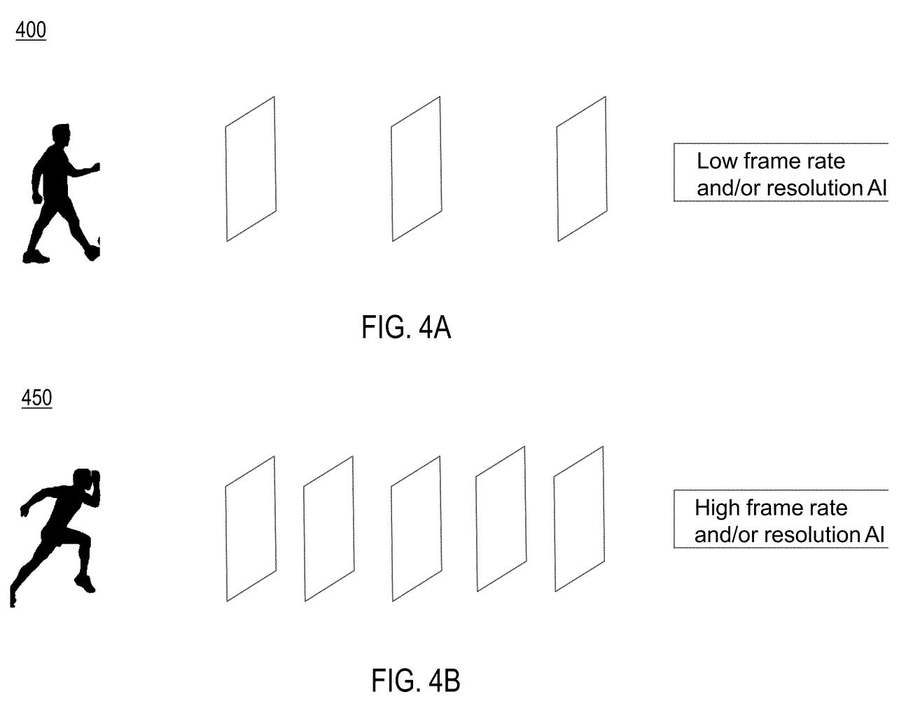

FIG. 4A and FIG. 4B illustrate an example of dynamic XR device adaptation for power consumption based on a movement or activity of a user wearing the XR device, according to an example implementation of the present disclosure. FIG. 4A and FIG. 4B illustrate exemplary operational scenarios 400, 450 of a device configured for dynamic adaptation of AI application frame rate and/or resolution.

In the scenario 400 shown in FIG. 4A, a device may operate in a mode characterized by a low frame rate and/or a low resolution for AI applications. This scenario typically arises when the device detects that the user is stationary or exhibiting minimal movement, as determined by integrated sensors (e.g., sensors 360) such as accelerometers, gyroscopes, and GPS receivers. The device’s controller (e.g., controller 350) may perform sensor fusion and activity recognition algorithms, identify periods or frequency of low mobility and correspondingly reduce the frame rate and/or resolution of data processed by the AI applications (e.g., AI applications 344). This reduction can minimize unnecessary data transmission and computational workload, thereby conserving battery power and prolonging device operational time.

Conversely, in the scenario 450 shown in FIG. 4B, the device may operate in a mode with a high frame rate and/or a high resolution for AI applications. This scenario may be triggered when the device detects rapid user movement or frequent changes in orientation, as captured by the same suite of sensors (e.g., sensors 360). The controller (e.g., controller 350) may respond by increasing the frame rate and/or resolution, ensuring that the AI applications receive timely and detailed data necessary for accurate scene analysis and/or responsive user interaction. This operational mode can be particularly beneficial in dynamic environments, such as when the user is walking, running, or actively engaging with augmented reality content. The system’s real-time adaptation to increased mobility can enhance AI performance and user experience.

Both FIG. 4A and FIG. 4B demonstrate the device’s capability to dynamically transition between low and high frame rate/resolution modes based on continuous monitoring of user activity (e.g., using sensors 360). In some embodiments, the application layer (e.g., data precision manager) can implement the adaptation logic by interfacing or interacting with the sensors and AI modules (e.g., AI application 344, AI input analyzer 348, AI server 390, on-device AI processor 346). In some embodiments, the controller can implement such adaptation logic by interfacing or interacting with the sensors and AI modules.

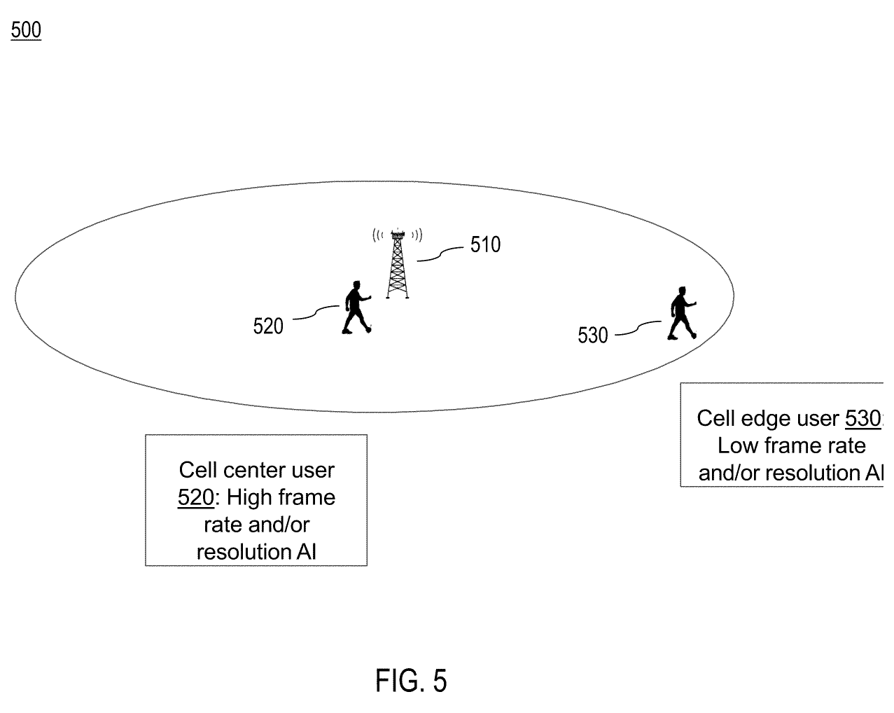

FIG. 5 illustrates an example of dynamic XR device adaptation for power consumption based on a quality of the wireless connectivity of an XR device, according to an example implementation of the present disclosure. FIG. 5 depicts a system environment 500 illustrating the dynamic adaptation of AI application frame rate and/or resolution in response to the cellular connectivity environment of a user device. The figure demonstrates how the system intelligently adjusts operational parameters to optimize both power consumption and AI performance, depending on whether the user device (e.g., UE) is located near the center of a cellular cell or at the cell edge.

In some embodiments, the user device can perform dynamic adaptation of frame rate and/or resolution depending on locations, e.g., depending on changing radio conditions from the center to the edge. For example, when the user device 520 is located near the cell 510, the user device may experience strong signal strength, high signal quality, and/or minimal interference. In this favorable connectivity scenario, the device can operate AI applications at a high frame rate and/or high resolution. The controller within the device (e.g., controller 350), informed by metrics such as RSSI, RSRP, and/or SINR, may determine that network conditions are optimal or the degree of cellular connectivity is high (e.g., greater than a predetermined threshold). Consequently, the device can transmit high-fidelity or high-precision data to cloud-based AI servers (e.g., AI server 390) or local AI servers (e.g., on-device AI processor 346), ensuring superior AI performance and user experience. This operational mode is particularly advantageous for applications requiring real-time responsiveness and detailed scene analysis.

In contrast, when user device 530 is located at the cell edge, where the user device may encounter degraded radio conditions, including a lower signal strength, an increased interference, and potential cell loading or congestion. In this scenario, the controller (e.g., controller 350) may detect that the device is operating under power-limited and/or connectivity-constrained conditions. To conserve battery life and maintain acceptable latency, the system (e.g., data precision manager 342 or controller 350) can dynamically reduce the frame rate and/or resolution of data processed by the AI applications. In some embodiments, the device may also switch from cloud-based AI processing (e.g., AI server 390) to on-device AI execution (e.g., on-device AI processor 346) when latency requirements cannot be met (e.g., the actual latency (in unit of time) is greater than a threshold representing a desirable/required latency) due to poor connectivity. This adaptive behavior can ensure that essential or minimal AI functions remain available to the user, even in challenging network environments, while minimizing power consumption and/or network resource usage.

The adaptation logic illustrated in FIG. 5 is implemented through continuous monitoring of cellular connectivity metrics (e.g., RSSI, RSRP, SINR, cell loading, and/or network congestion) and/or real-time adjustment of AI operational parameters. In some embodiments, the system can utilize hardware-level radio measurements (e.g., measurements at the PHY/MAC or network interface) and/or software-based activity recognition (e.g., using data obtained from sensors 360) to determine the optimal balance between power efficiency and AI performance.

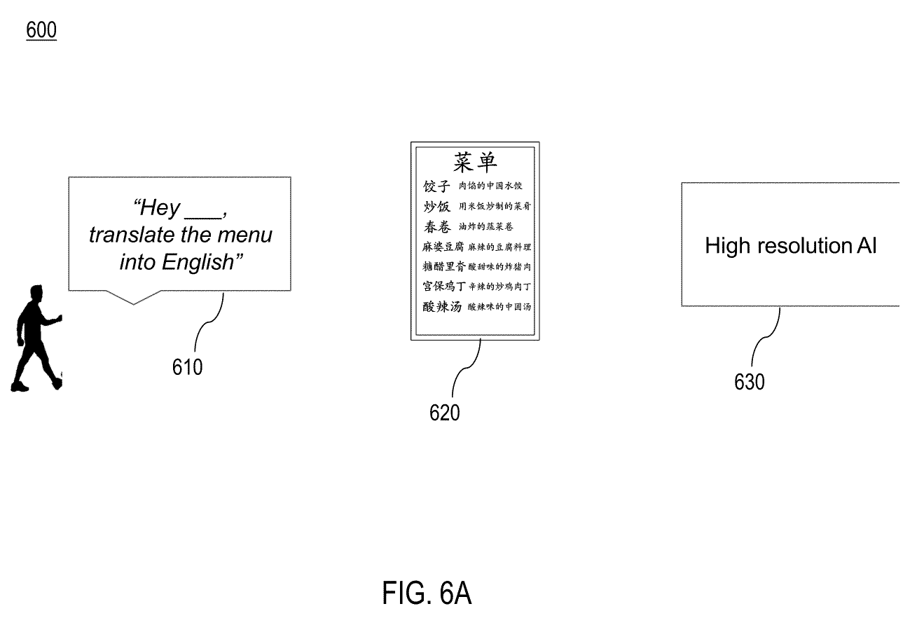

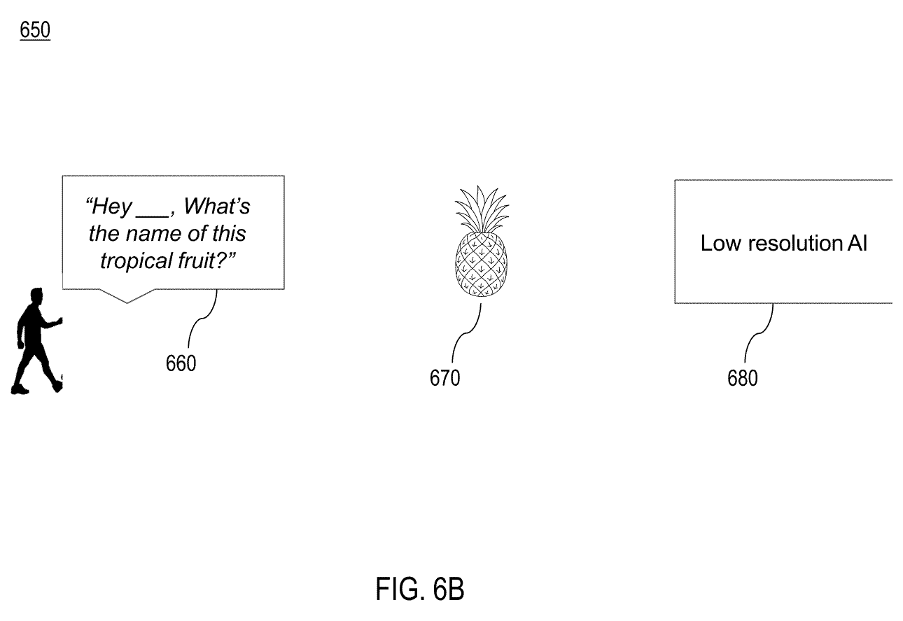

FIG. 6A and FIG. 6B illustrate an example of dynamic XR device adaptation for power consumption based on a requirement of a query of a user, according to an example implementation of the present disclosure. FIG. 6A and FIG. 6B illustrate different scenarios 600, 650 in which the dynamic adjustment of image resolution for AI applications is performed in response to the semantic requirements of user queries, as implemented in an XR or wearable device (e.g., AI input analyzer 348, data precision manager 342). These figures exemplify how the system intelligently analyzes the nature of a user’s request and adapts the resolution of image data transmitted to the AI engine, thereby optimizing both device power consumption and network resource usage.

The scenario 600 in FIG. 6A shows a device operating in a high-resolution mode for AI processing (e.g., high resolution AI application 630). This scenario may be triggered when the user issues a user query that requires detailed image analysis, such as “Translate the menu in Chinese into English” (user query 610). In some embodiments, the device (e.g., AI input analyzer 348) may perform semantic analysis of the user’s query and determine that high-resolution image data (e.g., high-resolution image data of the menu 620) is necessary to accurately process the request. In some embodiments, the data precision manager 342 may then configure the video codec and/or application layer (e.g., AI application 344) to capture and transmit high-resolution frames or images to the AI server, either locally (e.g., on-device AI processor 346) or remotely (e.g., AI server 390). This operational mode shown in scenario 600 can ensure that the AI application receives sufficient visual detail to perform complex tasks such as text recognition and/or translation.

In contrast, in the scenario 650 in FIG. 6B depicts the device operating in a low-resolution mode for AI processing (e.g., low resolution AI application 680). This scenario may arise when the user issues a query that can be satisfied with less detailed image data, such as “What’s the name of this tropical fruit?” (user query 660). In some embodiments, the device (e.g., AI input analyzer 348) may determine that only coarse visual features (e.g., coarse visual features of a fruit 670) are required for object recognition, and the data precision manager 342 may configure the system (e.g., application layer 340 including video codec 341, AI application 344) to capture and transmit low-resolution frames and/or low-resolution image data. By reducing the resolution, the device can conserve battery power and minimizes network bandwidth usage, while still providing accurate and timely responses to the user’s query.

The adaptation logic illustrated in FIG. 6A and FIG. 6B is implemented through real-time semantic analysis of user queries, dynamic configuration of image capture and/or transmission parameters (e.g., frame rate and/or resolution), and/or continuous monitoring of device power and network conditions. The figures visually distinguish between high-resolution and low-resolution operational modes, highlighting the system’s ability to optimize resource usage based on the specific requirements of each AI task.

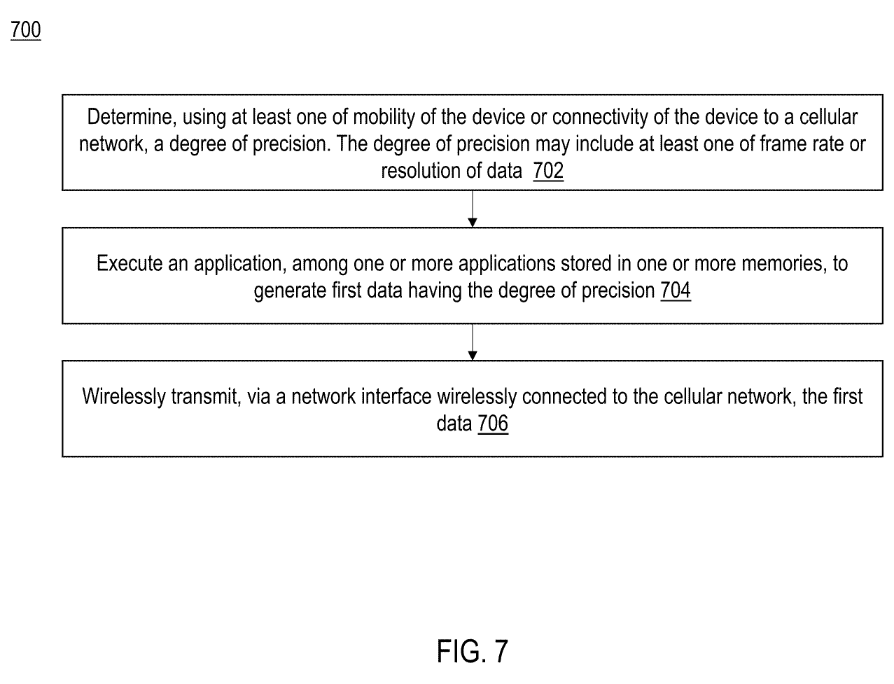

FIG. 7 is a flowchart showing a process 700 for dynamic XR device adaptation for power consumption, according to an example implementation of the present disclosure. In some embodiments, the process 700 is performed by a device (e.g., the device 300, the UE 120, or otherwise any device configured to perform adaptation for power consumption) including one or more processors (e.g., processors 224, controller 350, application layer 340), one or more memories (e.g., memories 226 or otherwise any memories one or more memories that can store one or more applications) and a transmitter or a network interface wirelessly connected to a cellular network (e.g., the wireless interface 222, network interface 310). In some embodiments, the process 700 may be performed by a UE configured to transmit data to a base station. In some embodiments, the process 700 is performed by other entities (e.g., user device configured to transmit data using wireless network protocols such as Wi-Fi, Bluetooth, etc. In some embodiments, the process 700 includes more, fewer, or different steps than shown in FIG. 7.

In some embodiments, in step 702, the one or more processors of a device (e.g., the device 300, the UE 120, controller 350) may determine, using at least one of mobility of the device or connectivity of the device to the cellular network , a degree of precision . The degree of precision may include at least one of frame rate or resolution of data . The term “degree of precision” of data may refer to any parameter or set of parameters that define the quality, fidelity, or granularity of data generated, processed, or transmitted by a device. In some embodiments, the degree of precision may include frame rate, resolution, bit depth, or other attributes relevant to the application or user query. The term “mobility” of a device may refer to any measure or indication of movement, displacement, or change in position of a device. Mobility may be determined using sensor data, such as accelerometer, gyroscope, GPS, or other location or motion indicators, and may reflect whether the device is stationary, moving slowly, or moving rapidly .

In some embodiments, the device may include one or more sensors (e.g., sensors 360). The one or more processors may be configured to determine, based on data obtained from the one or more sensors (e.g., accelerometer, gyroscope, or GPS receiver), a degree of mobility of the device (e.g., linear velocity, angular velocity, acceleration, inertial navigation system drift rates, handover, cell-reselection rates, Doppler shift values). The one or more processors may be configured to determine the degree of precision (e.g., frame rates, resolution) corresponding to the degree of mobility of the device such that a first degree of precision corresponding to a first degree of mobility higher than a second degree of mobility is higher than a second degree of precision corresponding to the second degree of mobility (e.g., the higher the degree of mobility is, the higher the frame rate/resolution is). In some embodiments, the one or more sensors may include at least one of accelerometer , gyroscope , or GPS receiver .

In some embodiments, the one or more processors may be configured to determine a degree of cellular connectivity of the device (e.g., signal strength, signal quality, degree of cell loading, degree of congestion) . The one or more processors may be configured to determine the degree of precision corresponding to the degree of cellular connectivity of the device such that a first degree of precision corresponding to a first degree of cellular connectivity greater than a second degree of cellular connectivity is higher than a second degree of precision corresponding to the second degree of cellular connectivity (e.g., the higher the degree of the cellular connectivity is, the higher the frame rate/resolution is).

In some embodiments, the one or more processors may be configured to determine the connectivity of the device to the cellular network using at least one of RSSI , RSRP, RSRQ, SINR, cell loading, or network congestion . In some embodiments, in determining the degree of cellular connectivity of the device, the one or more processors may be configured to determine whether cell loading is present or not . I n response to determining that cell loading is present, the one or more processors may be configured to decrease the degree of cellular connectivity of the device.

In some embodiments, in step 704, the one or more processors of the device may execute an application to generate first data having the degree of precision . For example, the one or more processors may execute the AI application 344 or video codec 341 to generate data (e.g., image or video data) having frame rate or resolution corresponding to the frame rate or resolution determined by the data precision manager 342 or controller 350.

In some embodiments, in step 706, the one or more processors of the device may wirelessly transmit, via the network interface (e.g., network interface 310), the first data. In some embodiments, the first data may be transmitted to a remote server (e.g., AI server 390, cloud AI server) implementing an artificial intelligence (AI) service configured to communicate with the application (e.g., AI application 344). The one or more memories may store a local server (e.g., on-device AI processor 346) implementing an AI service configured to communicate with the application (e.g., AI application 344). The one or more processors may be configured to determine that the degree of precision is greater than a threshold representing a latency requirement of the application (e.g., low latency required by XR, augmented reality (AR), virtual reality (VR), or mixed reality (MR) applications, interactive AI applications, video/audio call, autonomous driving systems, robotic control, ultra-reliable low-latency communication (URLLC)). A latency requirement of an application may refer to any constraint, threshold, or specification regarding the maximum allowable delay for processing, transmitting, or responding to data within an application. Latency requirements may be determined by user experience goals, application logic, or system capabilities.

In some embodiments, t he one or more processors may be configured to execute the application to generate second data having the degree of precision . T he one or more processors may be configured to execute the local server using the second data without transmitting the second data to the remote server . For example, with a limited power, the device may use a local AI server (e.g., on-device AI processor 346) rather than transmitting data to a remote AI server (e.g., AI server 390).

In some embodiments, the one or more processors may be configured to receive, from a user, third data to be input to a further application. In some embodiments, the third data may include a user query (e.g., user query 610, 660). The one or more processors may be configured to determine, based at least on the third data, a further degree of precision. The further degree of precision may include at least one of frame rate or resolution of data. The further degree of precision may include a resolution of image data. The resolution of image data may be determined by performing semantic analysis of the user query. The one or more processors may be configured to determine, using a result of the semantic analysis , a degree of resolution requirement representing a degree of resolution of image data that is required to process the user inquiry (e.g., a high degree of resolution of image may be required to process text recognition and translation as shown in FIG. 6A; a low degree of resolution of image may be required to process recognition of a simple object as shown in FIG. 6B). The one or more processors may be configured to determine the resolution of image data corresponding to the degree of resolution requirement such that a first resolution of image data corresponding to a first degree of resolution requirement higher than a second degree of resolution requirement is higher than a second resolution of image data corresponding to the second degree of resolution requirement (e.g., the higher the complexity of AI task is, the higher the frame rate or resolution is).

The one or more processors may be configured to execute the further application to generate fourth data having the further degree of precision . The one or more processors may be configured to wirelessly transmit, via the network interface, the fourth data . For example, in the scenario 600 in FIG. 6A, the one or more processors may generate and transmit high precision data (e.g., high frame rate/resolution), while in the scenario 650 in FIG. 6B, generating and transmitting low precision data (e.g., low frame rate/resolution).

### Example System Architecture

FIG. 8 illustrates an example environment suitable for dynamic extended reality (XR) device adaptation for power consumption, according to some embodiments. Environment 800 may include server(s) 830 communicatively coupled with client device(s) 810 and database 852 over a network 850. Client device(s) 810 may include any one of a laptop computer 810-5, a desktop computer 810-3, or a mobile device, such as a smartphone 810-1, a palm device 810-4, or a tablet device 810-2. In some embodiments, client device(s) 810 may include a headset or other wearable device 810-6 (e.g., an extended reality headset or smart glass, including a virtual reality (VR), augmented reality (AR), or mixed reality (MR) headset or smart glass), such that at least one participant may be running an extended reality (XR) application installed therein. In some embodiments, the solutions disclosed herein may implement cellular network technology (e.g., 3GPP Release 88 (5G-Advanced)).

### Hardware Overview

FIG. 9 is a block diagram illustrating exemplary computer system 900 with which client devices (e.g., client device(s) 810) may be implemented, according to some embodiments. In certain aspects, computer system 900 may be implemented using hardware or a combination of software and hardware, either in a dedicated server, or integrated into another entity, or distributed across multiple entities. Computer system 900 (e.g., client device(s) 810 and server(s) 180) may include processor 902, memory 904, data storage 906, bus 908, input/output module 910, communications module 912, input device 914, or output device 916.

Having now described some illustrative implementations, it is apparent that the foregoing is illustrative and not limiting, having been presented by way of example. In particular, although many of the examples presented herein involve specific combinations of method acts or system elements, those acts and those elements can be combined in other ways to accomplish the same objectives. Acts, elements and features discussed in connection with one implementation are not intended to be excluded from a similar role in other implementations or implementations.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device, etc.) may include one or more devices (e.g., RAM, ROM, Flash memory, hard disk storage, etc.) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit and/or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular can also embrace implementations including a plurality of these elements, and any references in plural to any implementation or element or act herein can also embrace implementations including only a single element. References in the singular or plural form are not intended to limit the presently disclosed systems or methods, their components, acts, or elements to single or plural configurations. References to any act or element being based on any information, act or element can include implementations where the act or element is based at least in part on any information, act, or element.

Any implementation disclosed herein can be combined with any other implementation or embodiment, and references to “an implementation,” “some implementations,” “one implementation” or the like are not necessarily mutually exclusive and are intended to indicate that a particular feature, structure, or characteristic described in connection with the implementation can be included in at least one implementation or embodiment. Such terms as used herein are not necessarily all referring to the same implementation. Any implementation can be combined with any other implementation, inclusively or exclusively, in any manner consistent with the aspects and implementations disclosed herein.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Systems and methods described herein may be embodied in other specific forms without departing from the characteristics thereof. References to “approximately,” “about” “substantially” or other terms of degree include variations of +/-10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

The term “coupled” and variations thereof includes the joining of two members directly or indirectly to one another. Such joining may be stationary (e.g., permanent or fixed) or moveable (e.g., removable or releasable). Such joining may be achieved with the two members coupled directly with or to each other, with the two members coupled with each other using a separate intervening member and any additional intermediate members coupled with one another, or with the two members coupled with each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References to “or” can be construed as inclusive so that any terms described using “or” can indicate any of a single, more than one, and all of the described terms. A reference to “at least one of ‘A’ and ‘B’” can include only ‘A’, only ‘B’, as well as both ‘A’ and ‘B’. Such references used in conjunction with “comprising” or other open terminology can include additional items.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

References herein to the positions of elements (e.g., “top,” “bottom,” “above,” “below”) are merely used to describe the orientation of various elements in the FIGURES. The orientation of various elements may differ according to other exemplary embodiments, and that such variations are intended to be encompassed by the present disclosure.

What is claimed is:

1. A device comprising:
a network interface wirelessly connected to a cellular network;
one or more memories storing one or more applications; and
one or more processors configured to:
determine, using at least one of mobility of the device or connectivity of the device to the cellular network, a degree of precision, wherein the degree of precision comprises at least one of frame rate or resolution of data;
execute an application to generate first data having the degree of precision; and
wirelessly transmit, via the network interface, the first data.

2. The device of claim 1, further comprising:
one or more sensors,
wherein the one or more processors are configured to:
determine, based on data obtained from the one or more sensors, a degree of mobility of the device; and
determine the degree of precision corresponding to the degree of mobility of the device such that a first degree of precision corresponding to a first degree of mobility higher than a second degree of mobility is higher than a second degree of precision corresponding to the second degree of mobility.

3. The device of claim 1, wherein the one or more sensors comprise at least one of
accelerometer, gyroscope, or Global Positioning System (GPS) receiver.

4. The device of claim 1, wherein the one or more processors are configured to:
determine a degree of cellular connectivity of the device; and
determine the degree of precision corresponding to the degree of cellular connectivity of the device such that a first degree of precision corresponding to a first degree of cellular connectivity greater than a second degree of cellular connectivity is higher than a second degree of precision corresponding to the second degree of cellular connectivity.

5. The device of claim 1, wherein the one or more processors are configured to determine the connectivity of the device to the cellular network using at least one of received signal strength indicator (RSSI), reference signal received power (RSRP), reference signal received quality (RSRQ), or signal-to-interference-plus-noise ratio (SINR).

6. The device of claim 1, wherein in determining the degree of cellular connectivity of the device, the one or more processors are configured to:
determine whether cell loading is present or not; and
in response to determining that cell loading is present, decrease the degree of cellular connectivity of the device.

7. The device of claim 1, wherein
the first data is transmitted to a remote server implementing an artificial intelligence (AI) service configured to communicate with the application,
the one or more memories stores a local server implementing an AI service configured to communicate with the application, and
the one or more processors are configured to:
determine that the degree of precision is greater than a threshold representing a latency requirement of the application;
execute the application to generate second data having the degree of precision; and
execute the local server using the second data without transmitting the second data to the remote server.

8. The device of claim 1, wherein the one or more processors are configured to:
receive, from a user, third data to be input to a further application;
determine, based at least on the third data, a further degree of precision, wherein the further degree of precision comprises at least one of frame rate or resolution of data;
execute the further application to generate fourth data having the further degree of precision; and
wirelessly transmit, via the network interface, the fourth data.

9. The device of claim 8, wherein
the third data comprises a user query,
the further degree of precision comprises a resolution of image data, and
the resolution of image data is determined by performing semantic analysis of the user query.

10. The device of claim 9, wherein the one or more processors are configured to:
determine, using a result of the semantic analysis, a degree of resolution requirement representing a degree of resolution of image data that is required to process the user inquiry; and
determine the resolution of image data corresponding to the degree of resolution requirement such that a first resolution of image data corresponding to a first degree of resolution requirement higher than a second degree of resolution requirement is higher than a second resolution of image data corresponding to the second degree of resolution requirement.

11. A method comprising:
determining, by one or more processors of a device, using at least one of mobility of the device or connectivity of the device to a cellular network, a degree of precision, wherein the degree of precision comprises at least one of frame rate or resolution of data;
executing, by the one or more processors, an application, among one or more applications stored in one or more memories, to generate first data having the degree of precision; and
wirelessly transmitting, via a network interface wirelessly connected to the cellular network, the first data.

12. The method of claim 11, further comprising:
determining, based on data obtained from one or more sensors, a degree of mobility of the device; and
determining the degree of precision corresponding to the degree of mobility of the device such that a first degree of precision corresponding to a first degree of mobility higher than a second degree of mobility is higher than a second degree of precision corresponding to the second degree of mobility.

13. The method of claim 11, wherein the one or more sensors comprise at least one of
accelerometer, gyroscope, or Global Positioning System (GPS) receiver.

14. The method of claim 11, further comprising:
determining a degree of cellular connectivity of the device; and
determining the degree of precision corresponding to the degree of cellular connectivity of the device such that a first degree of precision corresponding to a first degree of cellular connectivity greater than a second degree of cellular connectivity is higher than a second degree of precision corresponding to the second degree of cellular connectivity.

15. The method of claim 11, further comprising:
determining the connectivity of the device to the cellular network using at least one of received signal strength indicator (RSSI), reference signal received power (RSRP), reference signal received quality (RSRQ), or signal-to-interference-plus-noise ratio (SINR).

16. The method of claim 11, wherein determining the degree of cellular connectivity of the device comprises:
determining whether cell loading is present or not; and
in response to determining that cell loading is present, decreasing the degree of cellular connectivity of the device.

17. The method of claim 11, wherein
the first data is transmitted to a remote server implementing an artificial intelligence (AI) service configured to communicate with the application,
the one or more memories stores a local server implementing an AI service configured to communicate with the application, and
the method further comprises:
determining that the degree of precision is greater than a threshold representing a latency requirement of the application;
executing the application to generate second data having the degree of precision; and
executing the local server using the second data without transmitting the second data to the remote server.

18. The method of claim 11, further comprising:
receiving, from a user, third data to be input to a further application;
determining, based at least on the third data, a further degree of precision, wherein the further degree of precision comprises at least one of frame rate or resolution of data;
executing the further application to generate fourth data having the further degree of precision; and
wirelessly transmitting, via the network interface, the fourth data.

19. The method of claim 18, wherein
the third data comprises a user query,
the further degree of precision comprises a resolution of image data, and
the resolution of image data is determined by performing semantic analysis of the user query.

20. The method of claim 19, further comprising:
determining, using a result of the semantic analysis, a degree of resolution requirement representing a degree of resolution of image data that is required to process the user inquiry; and
determining the resolution of image data corresponding to the degree of resolution requirement such that a first resolution of image data corresponding to a first degree of resolution requirement higher than a second degree of resolution requirement is higher than a second resolution of image data corresponding to the second degree of resolution requirement.
